(19) United States
(12) Patent Application Publication
(10) Pub. No.: US 2026/0075228 A1
(43) Pub. Date: Mar. 12, 2026

(54) DIVISION MODES OF DERIVED TREE FOR VIDEO CODING

(71) Applicant: TENCENT TECHNOLOGY (SHENZHEN) COMPANY LIMITED, Shenzhen (CN)

(72) Inventor: Liqiang WANG, Shenzhen (CN)

(73) Assignee: TENCENT TECHNOLOGY (SHENZHEN) COMPANY LIMITED, Shenzhen, GD (CN)

(21) Appl. No.: 19/390,133

(22) Filed: Nov. 14, 2025

Related U.S. Application Data
(63) Continuation of application No. 17/982,134, filed on Nov. 7, 2022.
Application No. 17/982,134 is a continuation of application No. PCT/CN2021/131531, filed on Nov. 18, 2021.

(30) Foreign Application Priority Data
Dec. 3, 2020 (CN) 202011411681.2

(51) Int. Cl. H04N 19/44; H04N 19/159; H04N 19/176; H04N 19/96

(52) U.S. Cl. CPC H04N 19/44; H04N 19/159; H04N 19/176; H04N 19/96

(57) ABSTRACT

In a method for video decoding, a bitstream that includes coded information of at least a video image is received. The video image includes a current coding block that adopts a derived tree, the current coding block being divided into a smaller prediction block and a larger prediction block according to the derived tree, the larger prediction block having a side length that is not an integer power of 2. First and second sub coefficient blocks of different sizes for the larger prediction block are decoded from the coded information. The first and second sub coefficient blocks have side lengths that are integer powers of 2, a target division mode for dividing the larger prediction block into the first and second sub coefficient blocks being limited to one or two division modes. A reconstructed image is generated according to the first and second sub coefficient blocks.

### RELATED APPLICATIONS

The present application is a continuation of U.S. application Ser. No. 17/982,134, filed on Nov. 7, 2022 which is a continuation of International Application No. PCT/CN2021/131531, entitled “VIDEO DECODING METHOD AND APPARATUS, READABLE MEDIUM, ELECTRONIC DEVICE, AND PROGRAM PRODUCT” and filed on Nov. 18, 2021, which claims priority to Chinese Patent Application No. 202011411681.2, entitled “VIDEO DECODING METHOD AND APPARATUS, READABLE MEDIUM, ELECTRONIC DEVICE, AND PROGRAM PRODUCT” and filed on Dec. 3, 2020, which are hereby incorporated by reference in their entirety.

### FIELD OF THE TECHNOLOGY

This disclosure relates to the technical field of computers and communication, and including to a video decoding method and apparatus, a computer-readable storage medium, an electronic device, and a program product.

### BACKGROUND OF THE DISCLOSURE

In the field of video coding, division structures, such as a quad-tree (QT), a binary-tree (BT), and an extended quad-tree (EQT), are used in the related video coding standards for dividing a coding block. Furthermore, the concept of an intra derived tree (Intra DT) is also proposed.

However, an intra derived tree-based division mode generates a prediction block whose side length is not an integer power of 2, that is, the width or the height of the prediction block is not integer power of 2. A transform block generally does not cross a boundary of a prediction block to avoid excessive high frequency energy. In order to reduce the complexity of a hardware implementation, a prediction block is first divided into sub-blocks and then transformed in sub-blocks. However, the video coding efficiency is affected by an unreasonable division mode of a corresponding sub-block.

### SUMMARY

Embodiments of this disclosure provide a video decoding method and apparatus, a non-transitory computer-readable storage medium, an electronic device, and a program product, which can effectively improve the video coding efficiency at least to a certain extent.

Other features and advantages of this disclosure become apparent through the following detailed descriptions, or may be partially learned through the practice of this disclosure.

In an aspect, the embodiments of this disclosure provide a video decoding method. In the method, a coding block of a video image frame and a derived tree adopted by the coding block are acquired. A plurality of sub-blocks in the coding block is decoded, according to a target division mode corresponding to the derived tree, to obtain a plurality of sub-coefficient blocks. The target division mode is one of a plurality of additional division modes corresponding to the derived tree. The plurality of additional division modes is configured to divide a designated prediction block in the coding block with a side length that is not an integer power of 2 into sub-blocks with side lengths that are integer powers of 2. Reconstructed images are generated according to the derived tree adopted by the coding block and the plurality of sub-coefficient blocks.

In an aspect, the embodiments of this disclosure also provide a video decoding apparatus, which includes processing circuitry. The processing circuitry is configured to acquire a coding block of a video image frame and a derived tree adopted by the coding block. The processing circuitry is configured to decode, according to a target division mode corresponding to the derived tree, a plurality of sub-blocks in the coding block to obtain a plurality of sub-coefficient blocks, the target division mode being one of a plurality of additional division modes corresponding to the derived tree, the plurality of additional division modes being configured to divide a designated prediction block in the coding block with a side length that is not an integer power of 2 into sub-blocks with side lengths that are integer powers of 2. Further, the processing circuitry is configured to generate reconstructed images according to the derived tree adopted by the coding block and the plurality of sub-coefficient blocks.

In some embodiments of this disclosure, the plurality of additional division modes is configured to divide the designated prediction block in the coding block with the side length that is not the integer power of 2 into two sub-blocks with the side lengths that are the integer powers of 2.

In some embodiments of this disclosure, the derived tree includes a horizontal derived tree. The target division mode corresponding to the horizontal derived tree is configured to divide the designated prediction block in the coding block into the two sub-blocks in a height direction, a side length ratio of the two sub-blocks is 1:2 or 2:1, and a height of the designated prediction block is not the integer power of 2.

In some embodiments of this disclosure, the derived tree includes a vertical derived tree. The target division mode corresponding to the vertical derived tree is configured to divide the designated prediction block in the coding block into the two sub-blocks in a width direction, a side length ratio of the two sub-blocks is 1:2 or 2:1, and a width of the designated prediction block is not the integer power of 2.

In some embodiments of this disclosure, based on the above solutions, the processing circuitry is configured to perform an inverse quantization and an inverse transform on the sub-coefficient blocks in a predetermined order to obtain reconstruction residuals based on the derived tree adopted by the coding block being an intra derived tree. The processing circuitry is configured to reconstruct, according to the reconstruction residuals, images corresponding to the plurality of sub-blocks to generate the reconstructed images, one of the reconstructed images corresponding to a first sub-block being added to an intra prediction referenceable image region of a second sub-block during reconstruction, the first sub-block preceding the second sub-block.

In some embodiments of this disclosure, based on the above solutions, the processing circuitry is configured to perform the inverse quantization and the inverse transform on the sub-coefficient blocks from top to bottom based on the intra derived tree being an intra horizontal derived tree. The processing circuitry is configured to perform the inverse quantization and the inverse transform on the sub-coefficient blocks from left to right based on the intra derived tree being an intra vertical derived tree.

In some embodiments of this disclosure, based on the above solutions, the processing circuitry is further configured to perform the inverse quantization and the inverse transform on the sub-coefficient blocks to obtain reconstruction residuals corresponding to the plurality of sub-blocks based on the derived tree adopted by the coding block being an inter derived tree. The processing circuitry is configured to splice the reconstruction residuals corresponding to the plurality of sub-blocks to obtain a reconstruction residual of the plurality of sub-blocks. Further, the processing circuitry is configured to generate the reconstructed images according to the reconstruction residual of the plurality of sub-blocks.

In some embodiments of this disclosure, based on the above solutions, the target division mode is a preset division mode selected from the plurality of additional division modes corresponding to the derived tree.

In some embodiments of this disclosure, based on the above solutions, the processing circuitry is further configured to determine the target division mode according to identifier information in a coded bitstream, the target division mode being selected from a plurality of division modes based on a rate-distortion optimization, the plurality of division modes including the additional division modes corresponding to the derived tree and original division modes corresponding to the derived tree.

In some embodiments of this disclosure, based on the above solutions, the processing circuitry is configured to determine, according to an index identifier contained in a sequence header of a video image frame sequence, whether all coding blocks adopting one of a derived tree, an intra derived tree, and an inter derived tree in coded data adopt the target division mode.

According to an aspect of the embodiments of this disclosure, a non-transitory computer-readable storage medium is provided. The non-transitory computer-readable storage medium stores instruction which when executed by a processor cause the processor to implement any of the video decoding methods according to the foregoing embodiments.

According to an aspect of this embodiment of this disclosure, an electronic device is provided, including: one or more processors; and a storage apparatus, configured to store one or more programs, the one or more programs, when executed by the one or more processors, causing the one or more processors to implement the video decoding method according to the foregoing embodiments.

According to an aspect of this embodiment of this disclosure, a computer program product or a computer program is provided, the computer program product or the computer program including computer instructions, the computer instructions being stored in a computer-readable storage medium. A processor of a computer device reads the computer instructions from the computer-readable storage medium, and executes the computer instructions, so that the computer device performs the video decoding method provided in the various optional embodiments.

According to technical solutions of some embodiments of this disclosure, multiple sub-blocks in a coding block are decoded according to a target division mode corresponding to a derived tree adopted by the coding block, and improved division modes corresponding to the derived tree include a division mode for dividing a prediction block whose side length is not integer power of 2 in the coding block into two sub-blocks whose side length is integer power of 2. These sub-blocks belong to the same prediction block and have the same prediction information, so they have similar residual distributions. The division modes according to the embodiments of this disclosure ensure that a larger sub-block is adopted to improve the transform efficiency without increasing the cost of a hardware implementation, which in turn improves the final coding efficiency.

It is to be understood that the foregoing general descriptions and the following detailed descriptions are merely exemplary and explanatory, and are not intended to limit this disclosure.

### BRIEF DESCRIPTION OF THE DRAWINGS

To describe technical solutions in embodiments of this disclosure more clearly, the following briefly introduces accompanying drawings for describing the embodiments. The accompanying drawings in the following description show merely some embodiments of this disclosure. Other embodiments are within the scope of the present disclosure.

FIG. 1 is a schematic diagram of an exemplary system architecture to which the technical solutions of the embodiments of this disclosure are applicable.

FIG. 2 is a schematic diagram of a video coding apparatus and a video decoding apparatus in an exemplary streaming transmission system.

FIG. 3 is a basic flowchart of an exemplary video encoder.

FIG. 4 is a diagram of an exemplary scanning region marked by SRCC.

FIG. 5 is a schematic diagram of an exemplary scanning order of the marked scanning region.

FIG. 6 is a schematic diagram of an exemplary EQT-based division mode.

FIG. 7 is a flowchart of selection of an exemplary basic block division structure in AVS3.

FIG. 8 is a schematic diagram of an exemplary intra derived tree-based block division mode.

FIG. 9 is a flowchart of an exemplary video decoding method according to an embodiment of this disclosure.

FIG. 10 and FIG. 11 are schematic diagrams of improved division modes corresponding to horizontal derived trees according to embodiments of this disclosure.

FIG. 12 and FIG. 13 are schematic diagrams of improved division modes corresponding to vertical derived trees according to embodiments of this disclosure.

FIG. 14 is a schematic diagram of an improved division mode corresponding to a derived tree according to an embodiment of this disclosure.

FIG. 15 is a block diagram of a video decoding apparatus according to an embodiment of this disclosure.

FIG. 16 is a schematic structural diagram of a computer system of an electronic device suitable for implementation of the embodiments of this disclosure.

### DESCRIPTION OF EMBODIMENTS

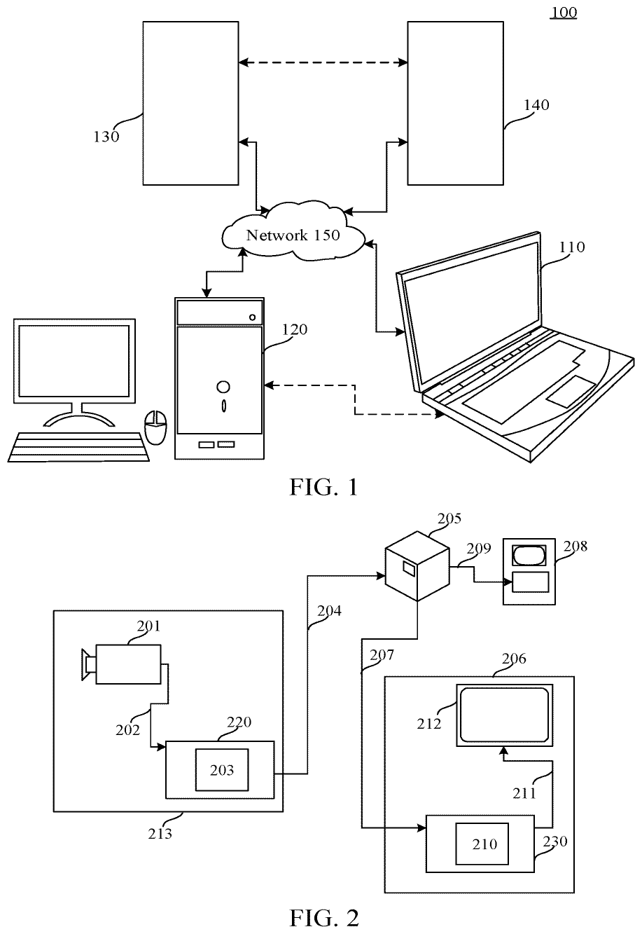

FIG. 1 shows a schematic diagram of an exemplary system architecture to which technical solutions of embodiments of this disclosure are applicable.

As shown in FIG. 1, the system architecture 100 includes multiple terminal apparatuses that can communicate with each other through a network 150. For example, the system architecture 100 may include a first terminal apparatus 110 and a second terminal apparatus 120 that are connected to each other through the network 150. In the embodiment in FIG. 1, the first terminal apparatus 110 and the second terminal apparatus 120 implement unidirectional data transmission.

For example, the first terminal apparatus 110 codes video data (e.g., video image streams acquired by the terminal apparatus 110) and then transmits the coded video data to the second terminal apparatus 120 through the network 150. The video data is transmitted in the form of one or more coded video code streams. The second terminal apparatus 120 receives the coded video data through the network 150, decodes the coded video data to restore the video data, and displays video frames according to the restored video data.

In an embodiment of this disclosure, the system architecture 100 further includes a third terminal apparatus 130 and a fourth terminal apparatus 140 that implement bidirectional transmission of coded video data. Bidirectional transmission is may be implemented, for example, during video conferencing or video calling. During bidirectional transmission, one of the third terminal apparatus 130 and the fourth terminal apparatus 140 can code video data (e.g., video image streams acquired by the terminal apparatus) and then transmit the coded video data to the other one of the third terminal apparatus 130 and the fourth terminal apparatus 140 through the network 150. One of the third terminal apparatus 130 and the fourth terminal apparatus 140 can also receive the coded video data transmitted by the other one of the third terminal apparatus 130 and the fourth terminal apparatus 140, decode the coded video data to restore the video data, and display video images on an accessible display apparatus according to the restored video data.

In the embodiment in FIG. 1, the first terminal apparatus 110, the second terminal apparatus 120, the third terminal apparatus 130, and the fourth terminal apparatus 140 may be servers, personal computers, and smart phones. However, the principle disclosed in this disclosure is not limited to such embodiments. The embodiments disclosed in this disclosure are merely exemplary and applicable to other devices, including laptop computers, tablet computers, vehicle terminals, smart home devices, media players and/or dedicated video conference devices. The network 150 may refer to any network that can be used to transmit coded video data between the first terminal apparatus 110, the second terminal apparatus 120, the third terminal apparatus 130, and the fourth terminal apparatus 140, and includes, for example, wired and/or wireless communication networks. The communication network 150 can exchange data in circuit-switched and/or packet-switched channels. The network may include a telecommunication network, a local area network, a wide area network and/or the Internet.

In an embodiment of this disclosure, FIG. 2 shows an exemplary system that includes a video coding apparatus and a video decoding apparatus in a streaming transmission environment. The subject disclosed in this disclosure is equally applicable to other applications supporting video, which include, for example, videoconferencing, digital television (TV), compressed videos stored in digital media including compact disks (CDs), digital versatile discs (DVDs), and memory sticks, etc.

A streaming transmission system may include an acquisition sub-system 213, which may include a video source 201 such as a digital camera and uncompressed video image streams 202 created by the video source 201. In the embodiments, the video image streams 202 include samples captured by a digital camera. Compared to coded video data 204 (or coded video code streams 204), the video image streams 202 are depicted as thick lines to emphasize the video image streams with a high data volume. The video image streams 202 can be processed by an electronic apparatus 220 including a video coding apparatus 203 coupled to the video source 201. The video coding apparatus 203 includes hardware, software or a combination of hardware and software to realize or implement various aspects of the disclosed subject that will be described in detail below.

Compared to the video image streams 202, the coded video data 204 (or the coded video code streams 204) are depicted as thin lines to emphasize the coded video data 204 (or the coded video code streams 204) with a relatively low data volume. The coded video data can be stored in a streaming transmission server 205 for future use. One or more streaming transmission client sub-systems, such as a client sub-system 206 and a client sub-system 208 in FIG. 2, access the streaming transmission server 205 to retrieve a copy 207 and a copy 209 of the coded video data 204.

The client sub-system 206 may include, for example, a video decoding apparatus 210 in an electronic apparatus 230. The video decoding apparatus 210 decodes the inputted copy 207 of the coded video data, and generates outputted video image streams 211 that can be presented on a display 212 (e.g., a display screen) or another presentation apparatus. In some streaming transmission systems, the coded video data 204, the video data 207, and the video data 209 (e.g., video code streams) are coded according to certain video coding/compression standards. The video coding/compression standards include ITU-T H.265. In the embodiments, a video coding standard under development may include versatile video coding (VVC). This disclosure is applicable to the context of the VVC standard as an example.

The electronic apparatus 220 and the electronic apparatus 230 may include other components not shown in the figures. For example, the electronic apparatus 220 includes a video decoding apparatus, and the electronic apparatus 230 further includes a video coding apparatus.

In an embodiment of this disclosure, international video coding standards such as High Efficiency Video Coding (HEVC) and versatile video coding (VVC), and Audio Video Coding are used as examples. After a video frame image is inputted, the video frame image is divided into several non-overlapping processing units according to the size of a block, and similar compression is performed on each processing unit. Such a processing unit is referred to as a coding tree unit (CTU), or referred to as a largest coding unit (LCU). A CTU can be subdivided into one or more basic coding units (CUs). A CU is the most basic element during coding. Some concepts about coding of a CU will be described below.

Predictive coding: predictive coding modes may include an intra prediction mode, an inter prediction mode, etc. An original video signal may be predicted based on a selected reconstructed video signal to obtain a residual video signal. A coding end needs to select a predictive coding mode for a current CU, and indicate the selected predictive coding mode to a decoding end. Intra prediction refers to prediction of signals from a region that has been coded and reconstructed of the same image. Inter prediction refers to prediction of signals from another image frame (referred to as a reference image) that has been coded and differs from a current image frame.

Transform & quantization: Transform, such as discrete Fourier transform and DCT, may be performed on the residual video signal to convert the signal to a transform domain, which is referred to as transform coefficients. Lossy quantization may further be performed on the transform coefficients to lose certain information, and the quantized signal is beneficial to compression representation. In some video coding standards, there are at least two transform modes to choose from. Therefore, the coding end also needs to select a transform mode for the current CU, and indicate the selected transform mode to the decoding end. The fineness of quantization is usually determined by quantization parameters (QPs). Large values of QPs indicate that coefficients in a large value range are quantized as the same input, which usually causes high distortion and low code rate. On the contrary, small values of QPs indicate that coefficients in a small value range are quantized as the same input, which usually causes low distortion and high code rate.

Entropy coding or statistical coding: Statistical coding and compression may be performed on the quantized transform domain signal according to the frequency of each value, and a binary (0 or 1) compressed code stream is eventually outputted. Meanwhile, other information, such as a selected coding mode and motion vector data, may be generated during coding. It may also be necessary to perform entropy coding on the information to reduce the code rate. Statistical coding is a lossless coding mode, which can effectively reduce the code rate required by expressing the same signal. Common statistical coding modes include variable length coding (VLC) and content adaptive binary arithmetic coding (CABAC).

Loop filtering: Inverse quantization, inverse transform, and predictive compensation may be performed on the transformed and quantized signal to obtain a reconstructed image. The reconstructed image differs from the original image in some information due to the effect of quantization, that is, the reconstructed image will produce distortion. Therefore, it may be beneficial to perform filtering, by a filter such as a deblocking filter (DB), sample adaptive offset (SAO), and an adaptive loop filter (ALF), on the reconstructed image to effectively reduce the degree of distortion produced by quantization. The filtered reconstructed image will be used as a reference for an image to be coded subsequently and used for predicting a future image signal. Therefore, the above filtering may also be referred to as loop filtering, that is filtering in a coding loop.

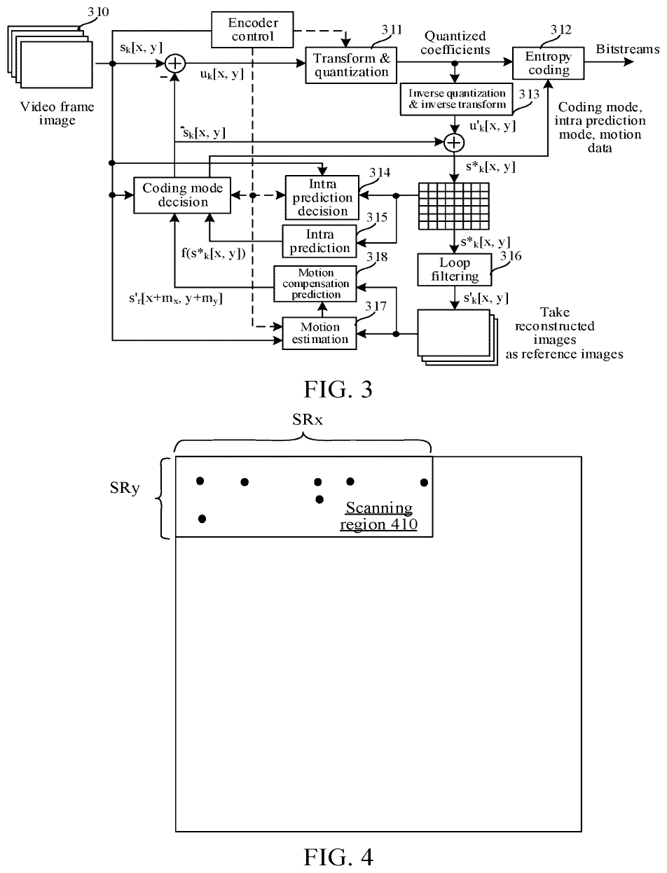

In an embodiment of this disclosure, FIG. 3 shows a basic flowchart of a video encoder, and the flow will be described below by taking intra prediction as an example. A difference operation is performed on an image signal sₖ[x,y] of an original video frame image 310 and a predicted image signal ŝₖ[x,y] to obtain a residual signal uₖ[x,y], and transform and quantization 311 are performed on the residual signal uₖ[x,y] to obtain quantized coefficients. On the one hand, entropy coding 312 is performed on the quantized coefficients to obtain coded bitstreams, and on the other hand, inverse quantization and inverse transform 313 are performed on the quantized coefficients to obtain a reconstructed residual signal

$${u}_{k}^{′} [ x , y ] .$$

The predicted image signal sₖ[x,y] and the reconstructed residual signal

$${u}_{k}^{′} [ x , y ]$$

are combined to generate an image signal

$${s}_{k}^{*} [ x , y ] .$$

On the one hand, the image signal

$${s}_{k}^{*} [ x , y ]$$

is inputted into an intra mode decision module 314 and an intra prediction module 315 and subjected to intra prediction, and on the other hand, a reconstructed image signal

$${s}_{k}^{′} [ x , y ]$$

is outputted by loop filtering 316. The reconstructed image signal

$${s}_{k}^{′} [ x , y ]$$

can be used as a reference image for the next frame and subjected to motion estimation 317 and motion compensation prediction 318. Then, a predicted image signal ŝₖ[x,y] of the next frame is obtained based on a result

$${s}_{r}^{′} [ x + {m}_{x} , y + {m}_{y} ]$$

of motion compensation prediction 318 and a result

$$f ( {s}_{k}^{*} [ x , y ] )$$

of intra prediction. The above process is continuously repeated until coding is completed.

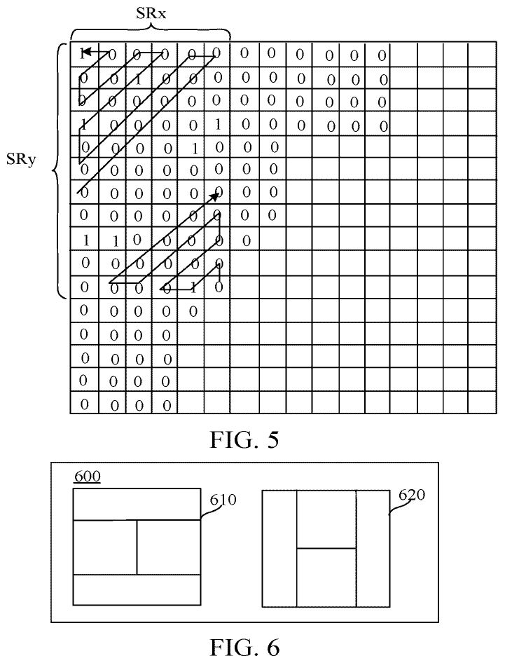

In addition, non-zero coefficients in a quantized coefficient block of a residual signal after transform and quantization are more likely to be concentrated in the left and upper regions of the block, and coefficients in the right and lower regions are usually 0. Therefore, SRCC is introduced. SRCC can mark the size SRx×SRy of the upper left region containing non-zero coefficients of each quantized coefficient block (with the size of W×H), where, SRx is an x coordinate of the rightmost non-zero coefficient in a quantized coefficient block, SRy is a y coordinate of the downmost non-zero coefficient in the quantized coefficient block, 1≤SRx≤W, 1≤SRy≤H, and coefficients outside the region are all 0. SRCC uses (SRx, SRy) to determine a quantized coefficient region to be scanned of a quantized coefficient block. As shown in FIG. 4, it is only necessary to code quantized coefficients in a scanning region 410 marked by (SRx, SRy). FIG. 5 shows a scanning order during coding, which is described by taking reverse zigzag scanning from the lower right corner to the upper left corner as an example.

Based on the above coding process, after acquiring a compressed code stream (e.g., a bitstream) of each CU, the decoding end performs entropy decoding to obtain various kinds of mode information and quantized coefficients. Then, inverse quantization and inverse transform are performed on the quantized coefficients to obtain a residual signal. On the other hand, a predicted signal corresponding to a CU can be obtained according to the known coding mode information, the residual signal and the predicted signal are added together to obtain a reconstructed signal, and loop filtering and other processing are performed on the reconstructed signal to generate a final output signal.

For the above coding process, AVS3 adopts a QT+BT+EQT basic block division structure. The previous AVS2 standard adopts a quad-tree (QT) division structure, that is, a CU is divided into four sub CUs. A BT-based division mode can divide a CU into left and right/upper and lower sub CUs. EQT-based division modes contain horizontal and vertical I-shaped division modes, and can divide a CU into four sub CUs. Specifically, as shown in FIG. 6, which is a schematic diagram of division of a CU block 600 according to an exemplary embodiment of this disclosure, the left CU block 610 adopts the horizontal I-shaped division mode, and the right CU block 620 adopts the vertical I-shaped division mode.

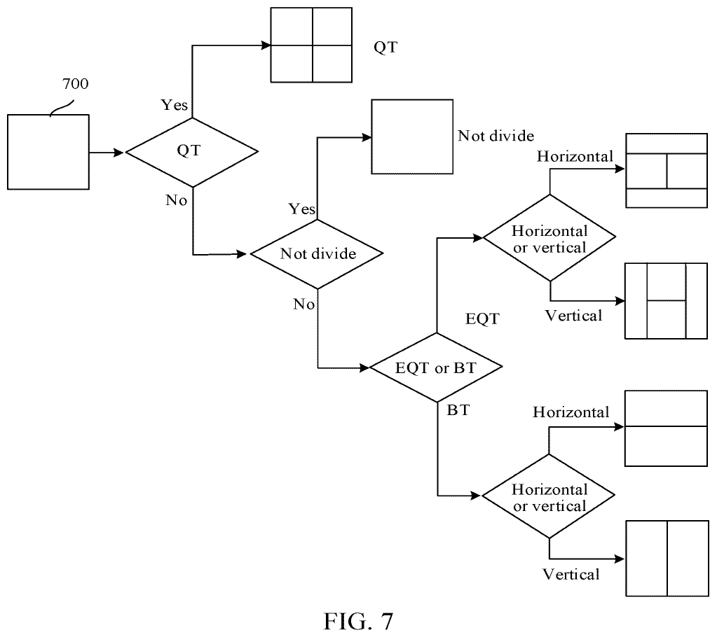

A representation of the QT+BT+EQT basic block division structure in AVS3 in a code stream is shown in FIG. 7. First whether a CU 700 is divided based on a QT is determined, and the CU 700 is directly divided based on the QT in a case that the QT is adopted. Whether the CU 700 is not divided is further determined in a case that the QT is not adopted, and the process ends in a case that the CU 700 is not divided. It is necessary to further determine whether the CU 700 is divided based on an EQT or a BT in a case that it is necessary to divide the CU700. Meanwhile, it is necessary to determine whether the CU 700 is divided horizontally or vertically regardless of whether the EQT or the BT is adopted. Block division is a recursive top-down division decision starting from an LCU, and the optimal division mode and coding mode are optimized and determined by the coding end in the recursive process.

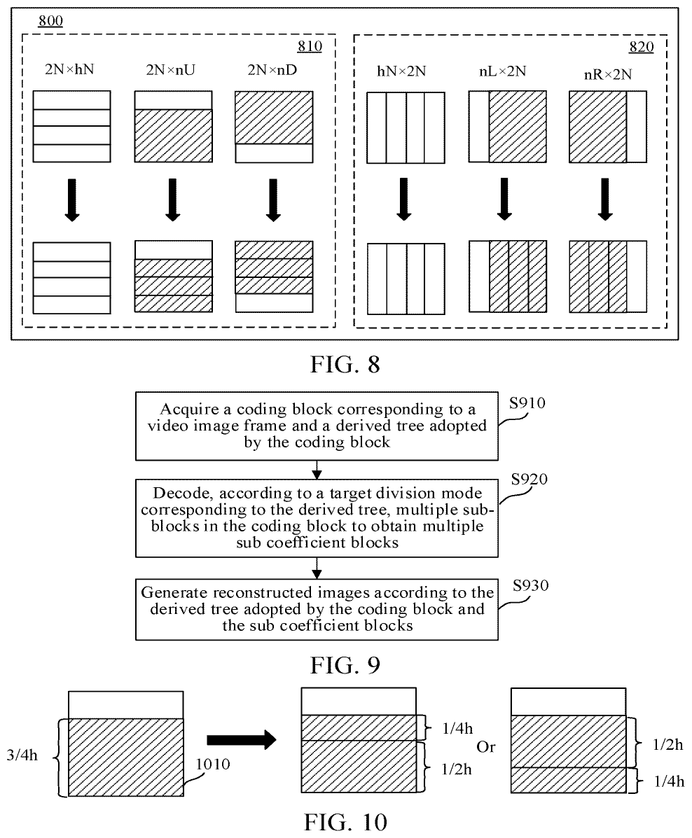

In addition, an intra derived tree (Intra DT) is also proposed in AVS3. This method adds the concept of a prediction unit (PU) on the basis of a coding unit, that is, a coding unit is subdivided into PUs. Furthermore, this method supports six PU division modes 800, which specifically include, as shown in FIG. 8, three horizontal division modes 810 (e.g., horizontal derived trees: 2N×hN, 2N×nU, and 2N×nD) and three vertical division modes 820 (e.g., vertical derived trees: hN×2N, nL×2N, and nR×2N). Meanwhile, use conditions of an Intra DT include that the maximum size of a coding unit is 64×64, the minimum size is 16×16, and the length-width ratio of a coding unit is less than 4.

Among the Intra DT-based division modes, 2N×hN and hN×2N divide a coding block into four prediction blocks, and the other four division modes (i.e. asymmetric derived trees: 2N×nU, 2N×nD, nL×2N, and nR×2N) divide a coding block into two prediction blocks. Each prediction block is used for coding a set of intra prediction information. Based on the asymmetric derived trees, the larger prediction block of the two prediction blocks will be subdivided into three sub-blocks.

As shown in FIG. 8, the three horizontal division modes 810 (e.g., 2N×hN, 2N×nU, and 2N×nD) horizontally divide a coding block into four identical sub-blocks, and the sub-blocks are reconstructed in sequence from top to down. The subsequent sub-block is reconstructed with reference to the previously reconstructed sub-block. The three vertical division modes (e.g., hN×2N, nL×2N, and nR×2N) vertically divide a coding block into four identical sub-blocks, and the sub-blocks are reconstructed in sequence from left to right. The subsequent sub-block is reconstructed with reference to the previously reconstructed sub-block.

Derived trees are also applicable to inter coding, so the derived trees can also be classified into intra derived trees and inter derived trees. Intra derived trees can further be classified into an intra horizontal derived tree and an intra vertical derived tree. Inter derived trees can further be classified into an inter horizontal derived tree and an inter vertical derived tree.

It can be seen that for the intra derived trees in AVS3, prediction blocks obtained based on 2N×hN and hN×2N and the smaller prediction blocks (black rectangles filled with white in FIG. 8) obtained based on the asymmetric derived trees are directly subjected to transform, quantization, and coefficient coding without division. For the larger prediction block (a shadow region shown in FIG. 8) with a size (the width or the height) of not integer power of 2 obtained by asymmetric division, it is subdivided into three identical sub-blocks and subjected to transform, quantization, and coefficient coding in sub-blocks. However, the three sub-blocks share the same intra prediction information, so they have similar residuals. The coding efficiency can be improved by using a larger transform block. Based on this, the embodiments of this disclosure provide the following solutions.

FIG. 9 shows a flowchart of a video decoding method according to an embodiment of this disclosure. The video decoding method can be implemented by a device having a computing processing function, such as a terminal device and a server. Referring to FIG. 9, the video decoding method at least includes step S910 to step S930, which will be described below.

In step S910, a coding block corresponding to a video image frame and a derived tree adopted by the coding block may be acquired. In an example, a coding block of a video image frame and a derived tree adopted by the coding block are acquired.

In an embodiment of this disclosure, a video image frame sequence includes a series of images, each image can be divided into slices, each slice can be subdivided into a series of LCUs (or CTUs), and each LCU includes several CUs.

During coding, the video image frame is coded in blocks. In some new video coding standards such as the H.264 standard, the concept of a macroblock (MB) is proposed. A macroblock can be divided into multiple prediction blocks for predictive coding. In the HEVC standard, the basic concepts such as a coding unit (CU), a prediction unit (PU), and a transform unit (TU) are adopted, and a variety of block units are obtained by functional division and described using a new tree structure. For example, a CU can be divided into smaller CUs according to a quad-tree, and each smaller CU can be subdivided to form a quad-tree structure. In the embodiments of this disclosure, the coding block may be a CU or a block smaller than a CU, such as a smaller block obtained by dividing a CU.

In an embodiment of this disclosure, the derived tree adopted by the coding block can be acquired by decoding a coded stream, which is any one of 2N×hN, 2N×nU, 2N×nD, hN×2N, nL×2N, and nR×2N shown in FIG. 8.

In step S920, according to a target division mode corresponding to the derived tree, multiple sub-blocks in the coding block may be decoded to obtain multiple sub coefficient blocks. In an example, a plurality of sub-blocks in the coding block is decoded, according to a target division mode corresponding to the derived tree, to obtain a plurality of sub-coefficient blocks. The target division mode is one of a plurality of additional division modes corresponding to the derived tree. The plurality of additional division modes is configured to divide a designated prediction block in the coding block with a side length that is not an integer power of 2 into sub-blocks with side lengths that are integer powers of 2.

The target division mode is selected from improved division modes corresponding to the derived tree, the improved division modes are used for dividing a designated prediction block in the coding block into two sub-blocks whose side length is integer power of 2, and the designated prediction block includes a prediction block whose side length is not integer power of 2.

In an embodiment of this disclosure, in a case that the derived tree is a horizontal derived tree, an improved division mode corresponding to the horizontal derived tree is used for dividing a first designated prediction block in the coding block into two sub-blocks in the height direction, a side length ratio of the two sub-blocks is 1:2 or 2:1, and the height of the first designated prediction block is not integer power of 2.

As shown in FIG. 10, based on the horizontal derived tree 2N×nU, the coding block is asymmetrically divided into two prediction blocks, and the height of the larger prediction block 1010 (a shadow region in FIG. 10) is not integer power of 2. According to the technical solutions of the embodiments of this disclosure, the prediction block 1010 can be divided into two sub-blocks in the height direction, and a side length ratio of the two sub-blocks is 1:2 or 2:1.

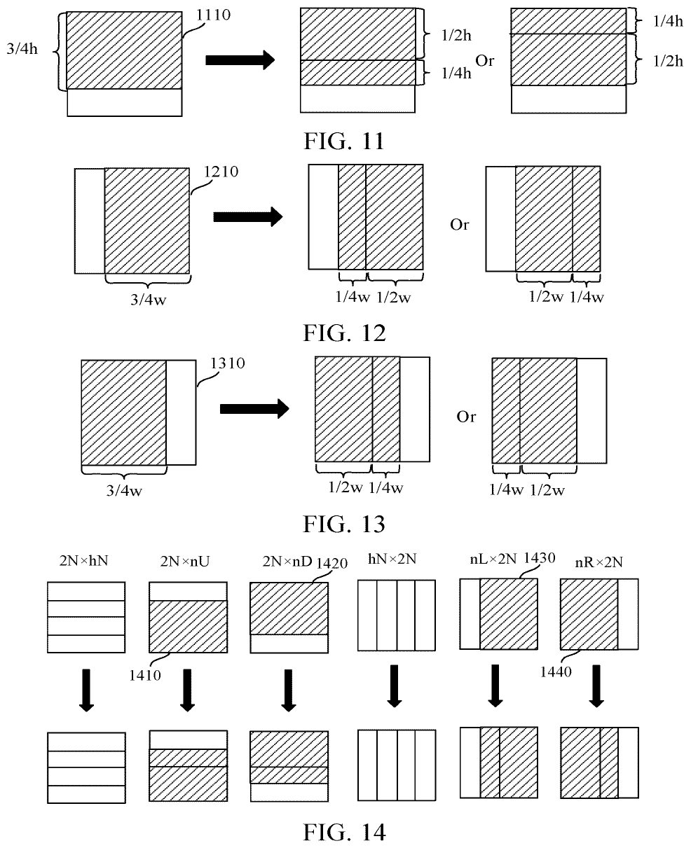

Similarly, as shown in FIG. 11, based on the horizontal derived tree 2N×nD, the coding block is asymmetrically divided into two prediction blocks, and the height of the larger prediction block 1110 (a shadow region in FIG. 11) is not integer power of 2. According to the technical solutions of the embodiments of this disclosure, the prediction block 1110 can be divided into two sub-blocks in the height direction, and a side length ratio of the two sub-blocks is 2:1 or 1:2.

In an embodiment of this disclosure, in a case that the derived tree is a vertical derived tree, an improved division mode corresponding to the vertical derived tree is used for dividing a second designated prediction block in the coding block into two sub-blocks in the width direction, a side length ratio of the two sub-blocks is 1:2 or 2:1, and the width of the second designated prediction block is not integer power of 2.

As shown in FIG. 12, based on the vertical derived tree nL×2N, the coding block is asymmetrically divided into two prediction blocks, and the width of the larger prediction block 1210 (a shadow region in FIG. 12) is not integer power of 2. According to technical solutions of the embodiments of this disclosure, the prediction block 1210 can be divided into two sub-blocks in the width direction, and a side length ratio of the two sub-blocks is 1:2 or 2:1.

Similarly, as shown in FIG. 13, based on the vertical derived tree nR×2N, the coding block is asymmetrically divided into two prediction blocks, and the width of the larger prediction block 1310 (a shadow region in FIG. 13) is not integer power of 2. According to the technical solutions of the embodiments of this disclosure, the prediction block 1310 can be divided into two sub-blocks in the width direction, and a side length ratio of the two sub-blocks is 2:1 or 1:2.

Based on technical solutions of the above embodiments, a division mode corresponding to each derived tree can be selected from the division modes shown in FIGS. 10 to 13. In an embodiment of this disclosure, an improved division mode corresponding to the derived tree is shown in FIG. 14. That is, based on the horizontal derived tree 2N×nU, the larger prediction block 1410 obtained by asymmetrical division is divided into two sub-blocks in the height direction, and a side length ratio of the two sub-blocks is 1:2. Based on the horizontal derived tree 2N×nD, the larger prediction block 1420 obtained by asymmetrical division is divided into two sub-blocks in the height direction, and a side length ratio of the two sub-blocks is 2:1. Based on the vertical derived tree nL×2N, the larger prediction block 1430 obtained by asymmetrical division is divided into two sub-blocks in the width direction, and a side length ratio of the two sub-blocks is 1:2. Based on the vertical derived tree nR×2N, the larger prediction block 1440 obtained by asymmetrical division is divided into two sub-blocks in the width direction, and a side length ratio of the two sub-blocks is 2:1.

In an embodiment of this disclosure, the target division mode of step S920 may be a preset division mode selected from the improved division mode corresponding to the derived tree. Thus, the coding end can divide the prediction block according to the preset division mode, and the decoding end can also perform reconstruction according to the preset division mode.

In an embodiment of this disclosure, the coding end can also use rate-distortion optimization (RDO) to make a decision so as to select the target division mode from multiple division modes, and adds an identifier of the target division mode to a code stream, and the decoding end can acquire the identifier information by decoding the code stream. In an example, the multiple division modes include the improved division modes corresponding to the derived tree and original division modes corresponding to the derived tree. The original division modes corresponding to the derived tree are shown in FIG. 8.

In an embodiment of this disclosure, coding blocks that need to be subjected to block division and decoding based on the target division mode can be determined according to an index identifier contained in a sequence header of coded data corresponding to the video image frame sequence.

For example, whether all coding blocks adopting a derived tree in coded data need to adopt a target division mode is determined according to an index identifier contained in a sequence header of a video image frame sequence. That is, whether coding blocks adopting a derived tree need to adopt a target division mode is determined according to a value of an index identifier in a sequence header of coded data corresponding to a video image frame sequence. For example, in a case that the index identifier in the sequence header is 1 (exemplary only), it is determined that the coding blocks that adopt the derived tree and correspond to the video image frame sequence need to be subjected to block division and decoding based on the target division mode.

In other some embodiments, whether all coding blocks adopting an intra derived tree in coded data need to be subjected to block division and decoding based on a target division mode is determined according to an index identifier contained in a sequence header of a video image frame sequence. That is, whether coding blocks adopting an intra derived tree need to adopt a target division mode is determined according to a value of an index identifier in a sequence header of coded data corresponding to a video image frame sequence. For example, in a case that the index identifier in the sequence header is 1 (exemplary only), it is determined that the coding blocks that adopt the intra derived tree and correspond to the video image frame sequence need to be subjected to block division and decoding based on the target division mode.

In addition, whether all coding blocks adopting an inter derived tree in coded data need to adopt a target division mode for block division and decoding can also be determined according to an index identifier contained in a sequence header of a video image frame sequence. That is, whether coding blocks adopting an inter derived tree need to adopt a target division mode is determined according to a value of an index identifier in a sequence header of coded data corresponding to a video image frame sequence. For example, in a case that the index identifier in the sequence header is 1 (exemplary only), it is determined that the coding blocks that adopt the inter derived tree and correspond to the video image frame sequence need to be subjected to block division and decoding based on the target division mode.

Further with response to FIG. 9, in step S930, reconstructed images are generated according to the derived tree adopted by the coding block and the sub coefficient blocks. In an example, reconstructed images are generated according to the derived tree adopted by the coding block and the plurality of sub-coefficient blocks.

In an embodiment of this disclosure, in a case that the coding block adopts an intra derived tree, inverse quantization and inverse transform are performed on the sub coefficient blocks obtained by decoding in sequence in a predetermined order to obtain reconstruction residuals, and images corresponding to the multiple sub-blocks are reconstructed in sequence according to the reconstruction residuals to generate reconstructed images. During reconstruction, an image corresponding to the succeeding sub-block can be reconstructed with reference to a reconstructed image corresponding to the preceding sub-block, that is, during reconstruction, a reconstructed image corresponding to a first sub-block is added to an intra prediction referenceable image region of a second sub-block, and the first sub-block precedes the second sub-block.

In an example, in a case that the intra derived tree is an intra horizontal derived tree, inverse quantization and inverse transform are performed on the sub coefficient blocks in sequence from top to down to obtain reconstruction residuals, and images corresponding to the multiple sub-blocks are reconstructed according to the reconstruction residuals. In a case that the intra derived tree is an intra vertical derived tree, inverse quantization and inverse transform are performed on the sub coefficient blocks in sequence from left to right to obtain reconstruction residuals, and images corresponding to the multiple sub-blocks are reconstructed according to the reconstruction residuals.

In an embodiment of this disclosure, in a case that the coding block adopts an inter derived tree, inverse quantization and inverse transform are performed on the sub coefficient blocks respectively to obtain reconstruction residuals respectively corresponding to the multiple sub-blocks, that is, inverse quantization and inverse transform can be performed on each sub coefficient block independently and concurrently to obtain reconstruction residuals, the reconstruction residuals respectively corresponding to the multiple sub-blocks are spliced to obtain a reconstruction residual corresponding to the whole of the multiple sub-blocks, and reconstructed images are generated according to the reconstruction residual corresponding to the whole of the multiple sub-blocks. That is, the reconstruction residual and prediction information are superposed to obtain reconstructed images.

The technical solutions of the above embodiments of this disclosure improve division modes corresponding to derived trees, so that the derived trees are applicable to intra coding and inter coding. Meanwhile, a larger sub-block is adopted to improve the transform efficiency without increasing the cost of a hardware implementation, which in turn improves the final coding efficiency.

The following describes apparatus embodiments of this disclosure, and the apparatus embodiments may be used for performing the video decoding method in the foregoing embodiment of this disclosure. For details not disclosed in the apparatus embodiments of this disclosure, reference is made to the embodiments of the foregoing video decoding method in this disclosure.

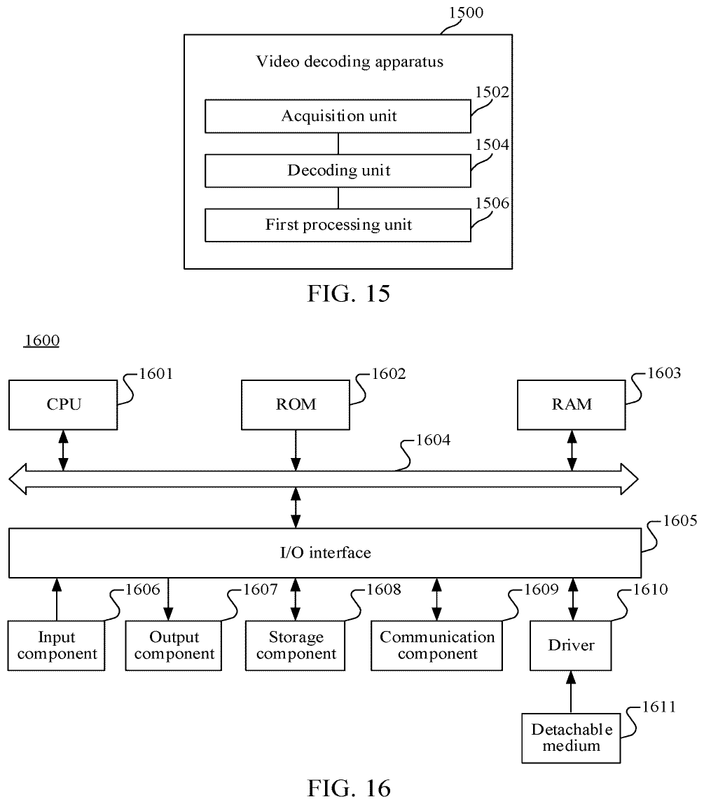

FIG. 15 shows a block diagram of a video decoding apparatus according to an embodiment of this disclosure. The video decoding apparatus may be arranged in a device having a computing processing function, such as a terminal device and a server.

Referring to FIG. 15, the video decoding apparatus 1500 according to an embodiment of this disclosure includes an acquisition unit 1502, a decoding unit 1504, and a first processing unit 1506. One or more modules, submodules, and/or units of the apparatus can be implemented by processing circuitry, software, or a combination thereof, for example.

The acquisition unit 1502 is configured to acquire a coding block corresponding to a video image frame and a derived tree adopted by the coding block. The decoding unit 1504 is configured to decode, according to a target division mode corresponding to the derived tree, multiple sub-blocks in the coding block to obtain multiple sub coefficient blocks. The target division mode is selected from improved division modes corresponding to the derived tree, the improved division modes are used for dividing a designated prediction block in the coding block into two sub-blocks whose side length is integer power of 2, and the designated prediction block includes a prediction block whose side length is not integer power of 2. The first processing unit 1506 is configured to generate reconstructed images according to the derived tree adopted by the coding block and the sub coefficient blocks.

In some embodiments of this disclosure, based on the above solutions, the derived tree includes a horizontal derived tree; and an improved division mode corresponding to the horizontal derived tree is used for dividing a first designated prediction block in the coding block into two sub-blocks in the height direction, a side length ratio of the two sub-blocks is 1:2 or 2:1, and the height of the first designated prediction block is not integer power of 2.

In some embodiments of this disclosure, based on the above solutions, the derived tree includes a vertical derived tree; and an improved division mode corresponding to the vertical derived tree is used for dividing a second designated prediction block in the coding block into two sub-blocks in the width direction, a side length ratio of the two sub-blocks is 1:2 or 2:1, and the width of the second designated prediction block is not integer power of 2.

In some embodiments of this disclosure, based on the above solutions, the first processing unit 1506 is further configured to: performing inverse quantization and inverse transform on the sub coefficient blocks in sequence in a predetermined order to obtain reconstruction residuals in a case that the coding block adopts an intra derived tree; reconstruct, according to the reconstruction residuals, images corresponding to the multiple sub-blocks in sequence to generate reconstructed images. During reconstruction, a reconstructed image corresponding to a first sub-block is added to an intra prediction referenceable image region of a second sub-block, and the first sub-block precedes the second sub-block.

In some embodiments of this disclosure, based on the above solutions, the first processing unit 1506 is further configured to: performing inverse quantization and inverse transform on the sub coefficient blocks in sequence from top to down in a case that the intra derived tree is an intra horizontal derived tree; and performing inverse quantization and inverse transform on the sub coefficient blocks in sequence from left to right in a case that the intra derived tree is an intra vertical derived tree.

In some embodiments of this disclosure, based on the above solutions, the first processing unit 1506 is further configured to respectively perform inverse quantization and inverse transform on the sub coefficient blocks to obtain reconstruction residuals respectively corresponding to the multiple sub-blocks in a case that the coding block adopts an inter derived tree; splice the reconstruction residuals respectively corresponding to the multiple sub-blocks to obtain a reconstruction residual corresponding to the whole of the multiple sub-blocks; and generate reconstructed images according to the reconstruction residual corresponding to the whole of the multiple sub-blocks.

In some embodiments of this disclosure, based on the above solutions, the target division mode is a preset division mode selected from the improved division modes corresponding to the derived tree.

In some embodiments of this disclosure, based on the above solutions, the decoding unit 1504 is further configured to: determine a target division mode according to identifier information obtained by decoding a code stream. The target division mode is selected from multiple division modes by a coding end based on a rate-distortion optimization policy, and the multiple division modes include the improved division modes corresponding to the derived tree and original division modes corresponding to the derived tree.

In some embodiments of this disclosure, based on the above solutions, the decoding unit 1504 is further configured to: determine, according to an index identifier contained in a sequence header of a video image frame sequence, whether all coding blocks adopting a derived tree in coded data need to adopt the target division mode; or determine, according to an index identifier contained in a sequence header of a video image frame sequence, whether all coding blocks adopting an intra derived tree in coded data need to adopt the target division mode; or determine, according to an index identifier contained in a sequence header of a video image frame sequence, whether all coding blocks adopting an inter derived tree in coded data need to adopt the target division mode.

FIG. 16 shows a schematic structural diagram of a computer system of an electronic device suitable for implementation of the embodiments of this disclosure.

A computer system 1600 of the electronic device shown in FIG. 16 is merely an example, and does not constitute any limitation to functions and use ranges of the embodiments of this disclosure.

As shown in FIG. 16, the computer system 1600 includes processing circuitry, such as a central processing unit (CPU) 1601, which may perform various suitable actions and processing based on a program stored in a read-only memory (ROM) 1602 or a program loaded from a storage part 1608 into a random access memory (RAM) 1603, for example, perform the method described in the foregoing embodiments. The RAM 1603 further stores various programs and data required for system operations. The CPU 1601, the ROM 1602, and the RAM 1603 are connected to each other by using a bus 1604. An input/output (I/O) interface 1605 is also connected to the bus 1604.

The following components are connected to the I/O interface 1605: an input part 1606 including a keyboard, a mouse, or the like, an output part 1607 including a cathode ray tube (CRT), a liquid crystal display (LCD), a speaker, or the like, a storage part 1608 including a hard disk, or the like, and a communication part 1609 including a network interface card such as a local area network (LAN) card or a modem. The communication part 1609 performs communication processing by using a network such as the Internet. A driver 1610 is also connected to the I/O interface 1605 as required. A removable medium 1611, such as a magnetic disk, an optical disc, a magneto-optical disk, or a semiconductor memory, is installed on the drive 1610 as required, so that a computer program read from the removable medium is installed into the storage part 1608 as required.

Particularly, according to an embodiment of this disclosure, the processes described above by referring to the flowcharts may be implemented as computer software programs. For example, an embodiment of this disclosure includes a computer program product. The computer program product includes a computer program stored in a computer-readable medium. The computer program includes a computer program used for performing a method shown in the flowchart. In such an embodiment, by using the communication part 1609, the computer program may be downloaded and installed from a network, and/or installed from the removable medium 1611. When the computer program is executed by the CPU 1601, various functions defined in the system of this disclosure are executed.

The computer-readable medium shown in the embodiments of this disclosure may be a computer-readable signal medium or a computer-readable storage medium or any combination thereof. The computer-readable storage medium may be, for example, but is not limited to, an electric, magnetic, optical, electromagnetic, infrared, or semi-conductive system, apparatus, or component, or any combination thereof. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof.

In this disclosure, the computer-readable storage medium (e.g., a non-transitory computer-readable storage medium) may be any tangible medium including or storing a program, and the program may be used by or used in combination with an instruction execution system, an apparatus, or a device. In this disclosure, the computer-readable signal medium may include a data signal transmitted in a baseband or as part of a carrier, and stores a computer-readable computer program. The propagated data signal may be in a plurality of forms, including but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in conjunction with an instruction execution system, an apparatus, or a device. The computer program included in the computer-readable medium may be transmitted by using any suitable medium, including but not limited to: a wireless medium, a wire, or the like, or any suitable combination thereof.

Flowcharts and block diagrams in the drawings illustrate architectures, functions, and operations that may be implemented by using the system, the method, and the computer program product according to the various embodiments of the present disclosure. Each box in a flowchart or a block diagram may represent a module, a program segment, or a part of code. The module, the program segment, or the part of code includes one or more executable instructions used for implementing specified logic functions. In some implementations used as substitutes, functions annotated in boxes may alternatively occur in a sequence different from that annotated in an accompanying drawing. For example, two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

Involved units described in the embodiments of this disclosure may be implemented in a software manner, or may be implemented in a hardware manner, and the described units may also be set in a processor. Names of the units do not constitute a limitation to the units in a specific case.

According to another aspect, this disclosure further provides a computer-readable medium. The computer-readable medium may be included in the electronic device described in the foregoing embodiments, or may exist alone without being assembled into the electronic device. The computer-readable medium carries one or more programs, the one or more programs, when executed by the electronic device, causing the electronic device to implement the method described in the foregoing embodiments.

Although a plurality of modules or units of a device configured to perform actions are discussed in the foregoing detailed description, such division is not mandatory. Actually, according to the implementations of this disclosure, the features and functions of two or more modules or units described above may be specifically implemented in one module or unit. On the contrary, the features and functions of one module or unit described above may be further divided to be embodied by a plurality of modules or units.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

According to the foregoing descriptions of the implementations, a person skilled in the art may readily understand that the exemplary implementations described herein may be implemented by using software, or may be implemented by combining software and necessary hardware. Therefore, the technical solutions of the implementations of this disclosure may be implemented in a form of a software product. The software product may be stored in a non-volatile storage medium (which may be a CD-ROM, a USB flash drive, a removable hard disk, or the like) or on a network, including several instructions for instructing a computing device (which may be a personal computer, a server, a touch terminal, a network device, or the like) to perform the methods according to the implementations of this disclosure.

The disclosed embodiments and implementations of the present disclosure are merely exemplary. This disclosure is intended to cover any variation, use, or adaptive change of this disclosure. These variations, uses, or adaptive changes follow the general principles of this disclosure.

It is to be understood that this disclosure is not limited to the exemplary structures described above and shown in the accompanying drawings, and various modifications and changes may be made without departing from the scope of this disclosure. Other embodiments are within the scope of the present disclosure.

What is claimed is:

1. A method for video decoding, comprising:
receiving a bitstream that includes coded information of at least a video image, the video image including a current coding block that adopts a derived tree, the current coding block being divided into a smaller prediction block and a larger prediction block according to the derived tree, the larger prediction block having a side length that is not an integer power of 2;
decoding, from the coded information and for the larger prediction block, a first sub coefficient block and a second sub coefficient block of different sizes, the first sub coefficient block and the second sub coefficient block having side lengths that are integer powers of 2, a target division mode for dividing the larger prediction block into the first sub coefficient block and the second sub coefficient block being limited to one or two division modes; and
generating a reconstructed image according to the first sub coefficient block and the second sub coefficient block.

2. The method according to claim 1, wherein:
a height of the larger prediction block is not the integer power of 2; and
a height ratio of the first sub coefficient block and the second sub coefficient block is limited to 1:2 or 2:1.

3. The method according to claim 1, wherein:
a width of the larger prediction block is not the integer power of 2; and
a width ratio of the first sub coefficient block and the second sub coefficient block is limited to 1:2 or 2:1.

4. The method according to claim 1, wherein
the current coding block is predicted based on intra prediction, and
the generating the reconstructed image comprises:
performing an inverse quantization and an inverse transform respectively on the first sub coefficient block and the second sub coefficient block to obtain a first reconstruction residual block and a second reconstruction residual block;
reconstructing, according to the first reconstruction residual block, a first sub block of the larger prediction block;
enlarging an intra prediction referenceable region for a second sub block of the larger prediction block to include the first sub block; and
reconstructing the second sub block of the larger prediction block based on the intra prediction referenceable region and the second reconstruction residual block.

5. The method according to claim 4, wherein the performing the inverse quantization and the inverse transform comprises:
performing the inverse quantization and the inverse transform on the first sub coefficient block and the second sub coefficient block from top to bottom when the current coding block is divided horizontally into the smaller prediction block and the larger prediction block; and
performing the inverse quantization and the inverse transform on the first sub coefficient block and the second sub coefficient block from left to right when the current coding block is divided vertically into the smaller prediction block and the larger prediction block.

6. The method according to claim 1, wherein
the current coding block is predicted based on inter prediction, and
the generating the reconstructed image comprises:
performing inverse quantization and inverse transform respectively on the first sub coefficient block and the second sub coefficient block to obtain a first reconstruction residual block and a second reconstruction residual block;
splicing the first reconstruction residual block and the second reconstruction residual block to obtain an entire reconstruction residual block for the larger prediction block; and
generating the reconstructed image according to the entire reconstruction residual block for the larger prediction block.

7. The method according to claim 1, wherein:
the target division mode is based on a preset division mode selected from two division modes.

8. The method according to claim 1, further comprising:
determining the target division mode according to identifier information in the coded information, the target division mode being selected from two division modes based on a rate-distortion optimization.

9. The method according to claim 1, further comprising at least one of:
determining, according to an index identifier in a sequence header for a video sequence including the video image, whether coding blocks adopting the derived tree use the target division mode;
determining, according to an index identifier in the sequence header, whether intra coding blocks adopting the derived tree use the target division mode; or
determining, according to an index identifier in a sequence header of at least the video image, whether inter coding blocks adopting the derived tree use the target division mode.

10. An apparatus for video decoding, comprising processing circuitry configured to:
receive a bitstream that incudes coded information of at least a video image, the video image including a current coding block that adopts a derived tree, the current coding block being divided into a smaller prediction block and a larger prediction block according to the derived tree, the larger prediction block having a side length that is not an integer power of 2;
decode, from the coded information and for the larger prediction block, a first sub coefficient block and a second sub coefficient block of different sizes, the first sub coefficient block and the second sub coefficient block having side lengths that are integer powers of 2, a target division mode for dividing the larger prediction block into the first sub coefficient block and the second sub coefficient block being limited to one or two division modes; and
generate a reconstructed image according to the first sub coefficient block and the second sub coefficient block.

11. The apparatus according to claim 10, wherein:
a height of the larger prediction block is not the integer power of 2; and
a height ratio of the first sub coefficient block and the second sub coefficient block is limited to 1:2 or 2:1.

12. The apparatus according to claim 10, wherein:
a width of the larger prediction block is not the integer power of 2; and
a width ratio of the first sub coefficient block and the second sub coefficient block is limited to 1:2 or 2:1.

13. The apparatus according to claim 10, wherein
the current coding block is predicted based on intra prediction, and
the processing circuitry is configured to:
perform an inverse quantization and an inverse transform respectively on the first sub coefficient block and the second sub coefficient block to obtain a first reconstruction residual block and a second reconstruction residual block;
reconstruct, according to the first reconstruction residual block, a first sub block of the larger prediction block;
enlarge an intra prediction referenceable region for a second sub block of the larger prediction block to include the first sub block; and
reconstruct the second sub block of the larger prediction block based on the intra prediction referenceable region and the second reconstruction residual block.

14. The apparatus according to claim 13, wherein the processing circuitry is configured to:
perform the inverse quantization and the inverse transform on the first sub coefficient block and the second sub coefficient block from top to bottom when the current coding block is divided horizontally into the smaller prediction block and the larger prediction block; and
perform the inverse quantization and the inverse transform on the first sub coefficient block and the second sub coefficient block from left to right when the current coding block is divided vertically into the smaller prediction block and the larger prediction block.

15. The apparatus according to claim 10, wherein
the current coding block is predicted based on inter prediction, and
the processing circuitry is configured to:
perform inverse quantization and inverse transform respectively on the first sub coefficient block and the second sub coefficient block to obtain a first reconstruction residual block and a second reconstruction residual block;
splice the first reconstruction residual block and the second reconstruction residual block to obtain an entire reconstruction residual block for the larger prediction block; and
generate the reconstructed image according to the entire reconstruction residual block for the larger prediction block.

16. The apparatus according to claim 10, wherein:
the target division mode is based on a preset division mode selected from two division modes.

17. The apparatus according to claim 10, wherein the processing circuitry is configured to:
determine the target division mode according to identifier information in the coded information, the target division mode being selected from two division modes based on a rate-distortion optimization.

18. The apparatus according to claim 10, wherein the processing circuitry is configured to perform at least one of:
determining, according to an index identifier in a sequence header for a video sequence including the video image, whether coding blocks adopting the derived tree use the target division mode;
determining, according to an index identifier in the sequence header, whether intra coding blocks adopting the derived tree use the target division mode; or
determining, according to an index identifier in a sequence header of at least the video image, whether inter coding blocks adopting the derived tree use the target division mode.

19. A non-transitory computer-readable storage medium storing instructions which when executed by at least one processor cause the at least one processor to perform:
receiving a bitstream that includes coded information of at least a video image, the video image including a current coding block that adopts a derived tree, the current coding block being divided into a smaller prediction block and a larger prediction block according to the derived tree, the larger prediction block having a side length that is not an integer power of 2;
decoding, from the coded information and for the larger prediction block, a first sub coefficient block and a second sub coefficient block of different sizes, the first sub coefficient block and the second sub coefficient block having side lengths that are integer powers of 2, a target division mode for dividing the larger prediction block into the first sub coefficient block and the second sub coefficient block being limited to one or two division modes; and
generating a reconstructed image according to the first sub coefficient block and the second sub coefficient block.

20. The non-transitory computer-readable storage medium according to claim 19, wherein
the current coding block is predicted based on intra prediction, and
the instructions cause the at least one processor to perform:
performing an inverse quantization and an inverse transform respectively on the first sub coefficient block and the second sub coefficient block to obtain a first reconstruction residual block and a second reconstruction residual block;
reconstructing, according to the first reconstruction residual block, a first sub block of the larger prediction block;
enlarging an intra prediction referenceable region for a second sub block of the larger prediction block to include the first sub block; and
reconstructing the second sub block of the larger prediction block based on the intra prediction referenceable region and the second reconstruction residual block.
